(19) United States
(12) Patent Application Publication
(10) Pub. No.: US 2018/0288454 A1
(43) Pub. Date: Oct. 4, 2018

(54) TECHNIQUES FOR ESTIMATING HTTP ADAPTIVE STREAMING (HAS) VIDEO QUALITY OF EXPERIENCE

(71) Applicants: Kamakshi Sridhar, Plano, TX (US); Jonathan Segel, Ottawa Ontario (CA)

(72) Inventors: Kamakshi Sridhar, Plano, TX (US); Jonathan Segel, Ottawa Ontario (CA)

(21) Appl. No.: 15/472,570

(22) Filed: Mar. 29, 2017

(51) Int. Cl. H04N 21/24; H04L 29/08; H04L 12/923; H04N 21/234

(52) U.S. Cl. CPC H04N 21/2401; H04L 67/02; H04N 21/2402; H04N 21/23406; H04L 47/762

(57) ABSTRACT

Techniques for estimating and improving a Quality of Experience (QoE) associated with a video stream played on user equipment are provided. The video stream may be an HTTP adaptive streaming (HAS) video flow, and a network element is configured to recognize certain aspects of the video flow and modify the delivery rate to improve the QoE without need additional information from either the user equipment (UE) or content provider. The network element may be configured to monitor the buffer at the UE to prevent underfill, configured to monitor multiple changes in delivery rate requests to prevent abrupt video presentation, and configured to recognize the initiation of a HAS video flow and increase buffer fill to reduce start-up time delay.

### BACKGROUND

### 1. Field of the Disclosure

The present disclosure relates to generally to video streaming and, more particularly, to techniques for estimating Quality of Experience (QoE) associated with HTTP Adaptive Streaming (HAS) of video flows.

### 2. Description of the Related Art

Mobile video traffic is rapidly growing in volume and is primarily delivered through encrypted HAS flows. Network operators would like to be able to ensure that users receive acceptable levels of QoE. In today's network, there are at least three different video impairments that impact a viewer's QoE: video screen freeze-up from buffer underrun, “jumps” in the video attributed to abrupt changes in coding rate, and poor overall video quality (associated with continued use of insufficiently high coding rate).

The task of assessing video QoE is near-real time is considered to be challenging. Existing schemes rely on the use of unencrypted packets where the HTTP packet headers can be accessed to provide detailed information about the coding scheme. However, most HAS video flows are encrypted, so the provider cannot look inside the packets to computer the user QoE. Inasmuch as each UE is different, with its own buffer depths and rate determining algorithms (RDAs) used in calling for delivery, there is no standard predictive model that can be used which would accurately predict the QoE associated with playing out a video stream on any given UE. Moreover, the UEs do not signal back the QoE that they are experiencing to the network, further hampering the ability of the network to monitor and improve the QoE.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in simplified form as a prelude to the more detailed description which follows.

In some embodiments, a method is provided for adaptive streaming of video content in wireless communication systems. The method includes monitoring, at a network element, changes in delivery rate requests for an HTTP adaptive streaming (HAS) video flow from a client user equipment (UE). The method also includes modifying, as needed, delivery rates of on-going video stream segments from the network element to the UE based on requested changes to improve Quality of Experience (QoE).

In some embodiments, an apparatus is provided for adaptive streaming in wireless communication systems. The apparatus takes the form of a network element within the wireless communication system and includes a process configured to monitor changes in delivery rate requests for an HTTP adaptive streaming (HAS) video flow from a client user equipment (UE). The apparatus is also configured to modify, as needed, delivery rates of on-going video stream segments from the network element to the UE based on requested changes to improve Quality of Experience (QoE).

In some embodiments, a non-transitory computer readable medium embodying a set of instructions is provided for monitoring changes in delivery rate requests for an HTTP adaptive streaming (HAS) video flow from a client user equipment (UE), and modifying, as needed, delivery rates of on-going video stream segments from the network element to the UE based on requested changes to improve Quality of Experience (QoE).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example of a wireless communication system that may implement network-based improvements in QoE for HAS video streams according to some embodiments.

FIG. 2 is a diagram illustrating a set of HAS chunks as delivered over time.

FIG. 3 is a diagram illustrating an ability to change coding levels for HAS chunks as transmitted through a wireless communication network from a content provider to a user equipment.

FIG. 4 is a graph illustrating an initial burst of video frames for filling a buffer within user equipment, followed by a steady-state delivery occurring at a rate that is throttled back from the initial burst rate.

FIG. 5 is a flowchart depicting an example of a method of monitoring buffer fill according to some embodiments.

### DETAILED DESCRIPTION

Congestion and fluctuating radio conditions over the air interface in a wireless network can result in significant changes in available bandwidth on timescales that are comparable to, or even shorter than, the playout duration of a segment of video content being streamed by mobile user equipment (UE). Consequently, delivery times averaged over multiple segments may not accurately represent the available bandwidth in subsequent time intervals. Requesting delivery of segments of video content over a wireless network at quality levels that are determined based on average delivery times for segments may therefore lead to buffer underflow, irregular playout, and a reduced end-user QoE.

As discussed in detail below, various techniques are proposed to be implemented at a location in the network between the content provider and the UE (for example, at a radio access network point) to study the flow of information in both directions, infer the status of the UE buffer and playout quality and, as a result, provide improvements to the end-user QoE without having to obtain additional information from either the content source or the UE itself.

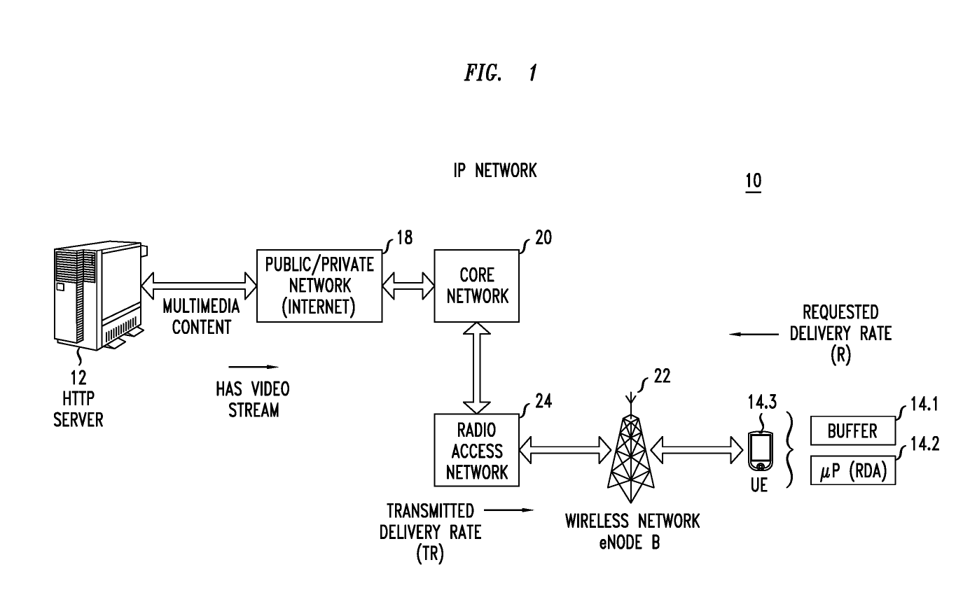

FIG. 1 is a diagram of an example of a wireless communication system 10 within which the disclosed techniques may be employed. In this example, wireless communication system 10 illustrates the flow of HAS video from an example HAS server 12 to an end-user (UE) 14, where UE 14 may comprise a mobile phone, tablet, laptop, or any other well-known type of mobile communication device including components necessary for receiving and playing out a received video stream. In this example shown in FIG. 1, UE 14 is illustrated as including a buffer 14.1 for storing the incoming video segments, a processor 14.2 for implementing a rate determining algorithm (RDA) used in select a desired delivery rate for a future video segment, and a display screen 14.3 for viewing received video segments.

HAS server 12 can interface with a public or private network 18 (or the Internet) in communication with a core network 20 of a wireless wide area network (WAN). Core network 20 can access a wireless network 22, such as an evolved packet system (EPS) via a radio access network (RAN) 24. RAN 24 functions to provide the multimedia content to UE 14 via a node (e.g. an evolved Node B (eNB)). It is to be understood that the details of the specific network architecture are not relevant to the disclosed techniques associated with improving end-user QoE of video flows as presented in this disclosure, as long as the network includes one or more HAS servers functioning as a source of the video content, an end-user client device for receiving and playing out the streaming video, with a network connecting the server and UE in a manner that provides a sufficient QoE for the user.

The QoE of HAS video can be affected by the one or more servers hosting the representations and the corresponding segments of the specific video source. Servers are known to have a limited operational capacity. If a specific server becomes overloaded and is unable to deliver content in a proper time frame, there is no way for the server to inform UE 14 to reduce its download rate from the server to avoid potential segmented retrieval delay and/or large packet loss.

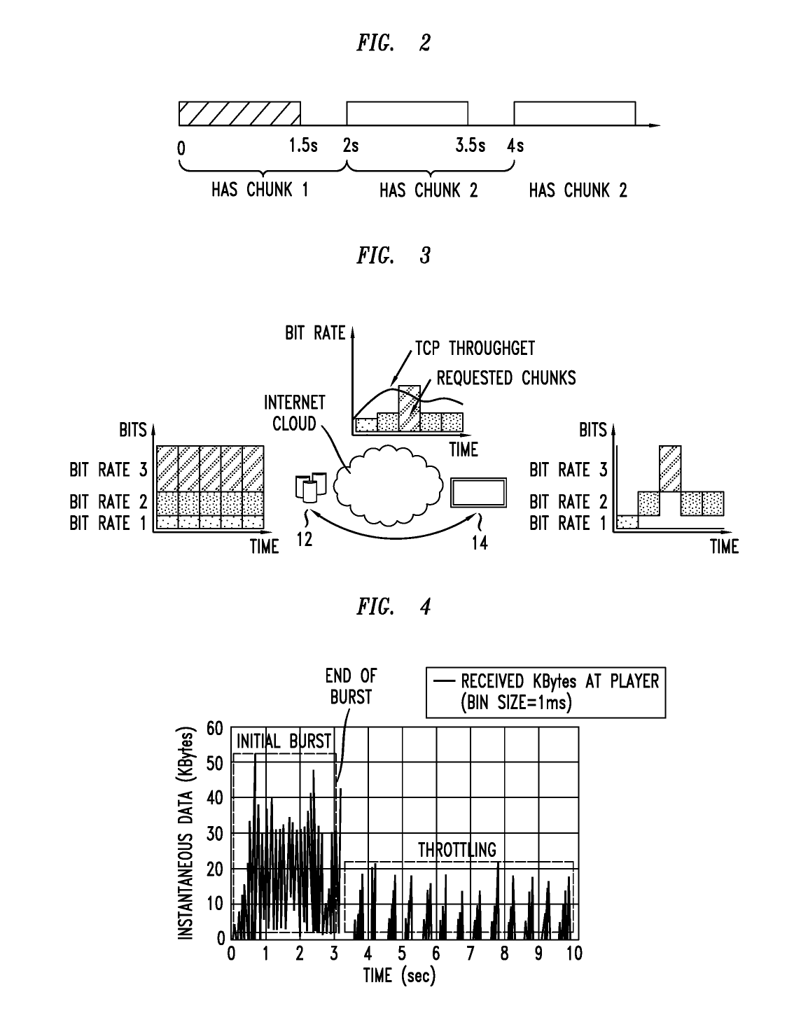

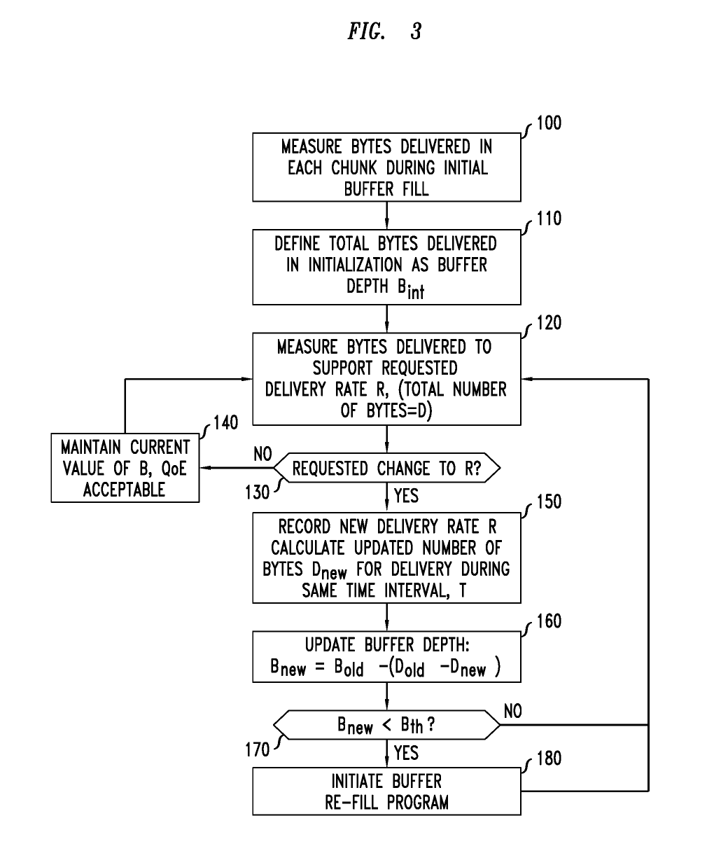

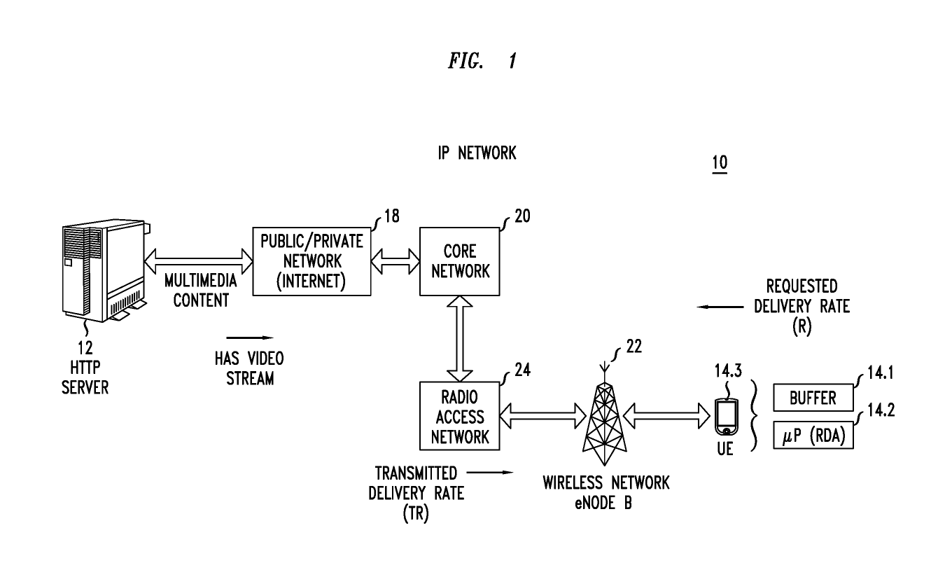

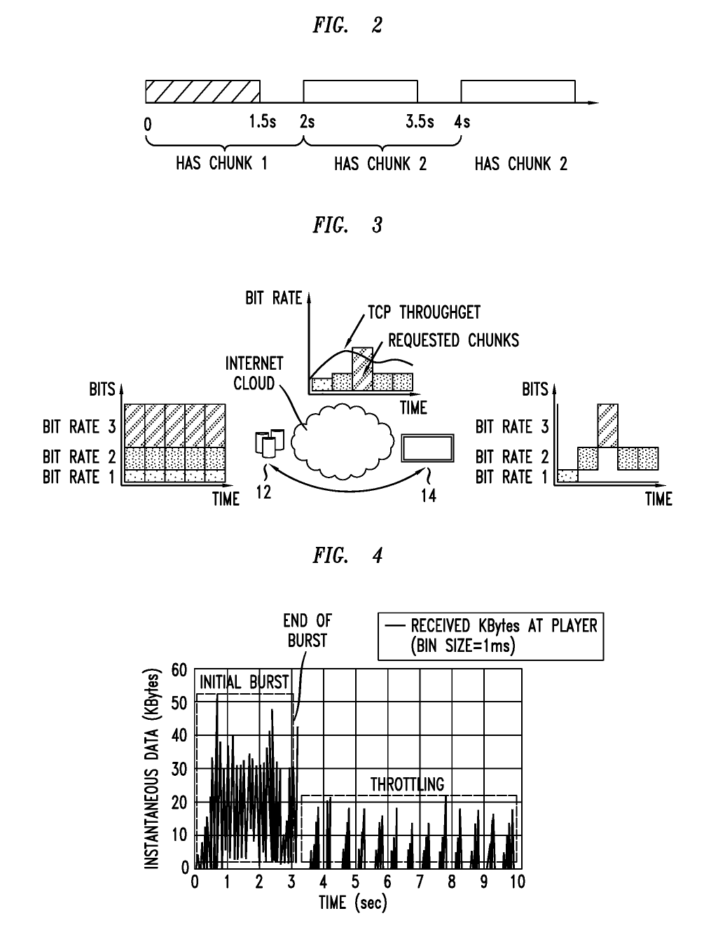

In addition, the network itself can have limited bandwidth. When multiple clients share a common, limited bandwidth and contend for resources, it is likely that the presence of several HAS video streams to multiple users will result in network congestion, reducing the playback experience at the UEs. Additionally, streaming video flows, such as HAS flows, tend to be long in duration and may last on the order of several minutes. FIG. 2 depicts an exemplary HAS delivery, comprising long duration “chunks” of data, with silences between the chunks. The average bit rate is typically between about 0.5 Mbps to 1.0 Mbps. In a HAS flow, the objective is to deliver the chunk in a certain time interval known as the “chunk duration”, this time interval generally being in the range of 2-10 seconds in length. The illustration of FIG. 2 shows a chunk duration time interval of 2 seconds.

The client UE uses, for example, HTTP get to request chunks. Each chunk (i.e., section of video content) is encoded at multiple, different bit rates, providing multiple quality levels available for transmission. HAS server 12 transmits these multiple versions of each chunk to RAN 24, as depicted in the diagram of FIG. 3 (illustrating the use of three different bit rates). The RDA embedded within processor 14.2 of client UE 14 requests the certain quality level (defined hereinafter as the “requested delivery rate”) based on the QoE it associated with the previously-delivered chunk. If processor 14.2 determines that the previous chunk was successfully received, the RDA will continue to request the same delivery rate R. Alternatively, the RDA determines that the UE experienced problems with the previously-received video segment, it will request a different (lower) deliver rate R_{new} for the next chunk. Thus, as a function of time, UE 14 may receive sequential packets encoded at different bit rates. FIG. 4 illustrates this principle, showing the on-going change in delivery rate as determined by the operation of the RDA over time.

There are two distinct phases associated client buffer fill during HAS video flow. First, there is an initial burst of transmission where RAN 24 attempts to fill the client UE buffer 14.1 up to a sufficient depth, where this takes place prior to the initiation of video playback. After the initial burst (or when the buffer acknowledges in another way that it is full), processor 14.2 will begin to request subsequent video chunks at a “lower” on-going delivery rate (i.e., the client UE goes into steady-state mode) and playback on UE screen 14.3 begins. In steady state, therefore the incoming transmission rate from RAN 24 is throttled back from the initial burst rate. Thereafter, processor 14.2 continues to monitor the incoming stream in an attempt to maintain a rate that provides a reliable QoE for the user.

FIG. 4 is a graph depicting the “initial burst” and “steady state” operation phases for HAS video streaming. Since RAN 24 knows how many bytes it delivered during the time period associated with the initial burst fill, this information may be used by RAN 24 in accordance with the principles of the disclosed subject matter to approximate the depth of UE buffer 14.1. As long as RAN 24 continues to transmit the video stream at a transmission rate TR that matches the requested delivery rate R, the RDA will continue to request the same delivery rate R and the user's experience in watching the video is satisfactory.

As mentioned above, there are a variety of factors beyond the control of the content provider, the network, and the client which impact the QoE. As also mentioned above, since HAS is an encrypted video flow, there is little that the content provider or UE can do to address transmission rate problems. If there is underdelivery from the network (due to congestion, for example), the RDA (as implemented by UE processor 14.2) will respond by requesting a lower delivery rate (which obviously exhibits a lower quality level). Accordingly, RAN 24 adapts to a lower transmission rate. The end user QoE will in all likelihood drop as a result, but there is no way for RAN 24 or the content provider (HAS server 12) to know that this is occurring so that the problem(s) can be addressed.

Indeed, network operators would like to provide optimum levels of user QoE for video flows and would therefore likely support network element features and algorithms that do so. As will be discussed in detail hereinbelow, various embodiments of the present disclosure provide techniques for assessing and improving user QoE (particularly related to HAS encrypted video flows) within the network itself (for example, at the RAN), without needing to obtain data from either the content provider or the end user.

Accordingly, one or more embodiments of the present disclosure provided intuitive assessments of major QoE impairments associated with video streaming and provide specific techniques for addressing and overcoming these impairments. One major impairment to video QoE is associated with buffer underruns, which cause the video screen to freeze up. This happens when the buffer on the UE becomes empty, and the video pauses to allow for the buffer to refill. This pause is immediately visible to the end user.

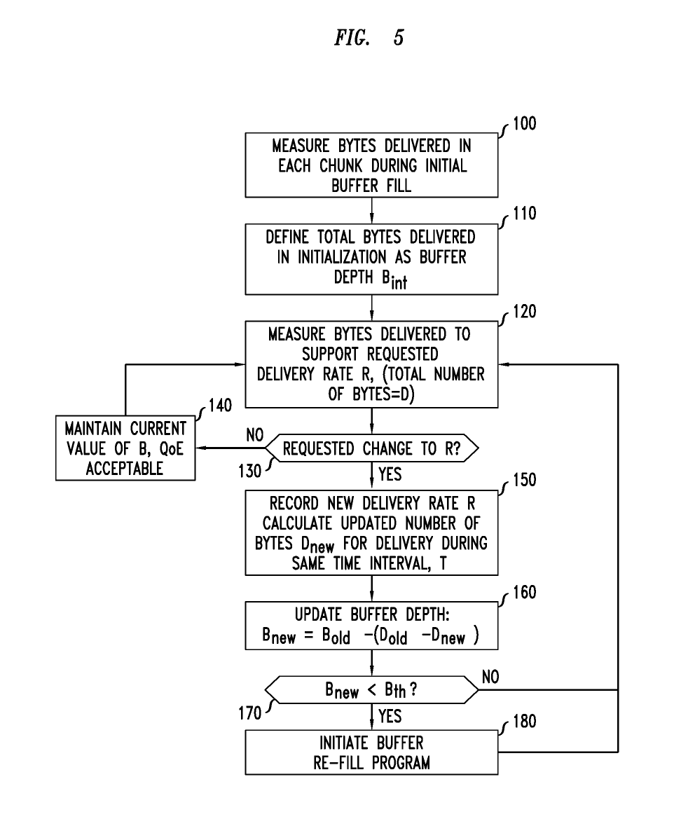

An example embodiment of the present disclosure addresses this problem of video screen freeze, and is discussed with reference to the flow chart of FIG. 5. The goal is to detect buffer underrun events at RAN 24 (or other location within the network that is accessible by the network operator) and initiate a process to refill the buffer before it drops to a level that triggers video screen freeze. In one case, RAN 24 is configured to maintain a running estimate of the buffer depth (for a particular UE receiving a video stream) and initiate a refill process when the buffer depth drops below a predetermined threshold level (Bₜₕ).

Referring to the flowchart of FIG. 5, an example of a suitable process is shown that may be employed at the RAN to implement buffer refill and prevent screen freeze. The process begins at step 100 by measuring, at RAN 24, the number of bytes delivered to a specific UE 14 in each chunk during the initial burst. The total number of bytes delivered at the end of the initial burst can be presumed to have filled UE buffer 14.1 (inasmuch as playback of the video has not yet begun), or if not completely filled this total number is a satisfactory measure to be used in the exemplary method. This total number of initial bytes is defined as an initial buffer depth Bᵢₙₜ (step 110).

RAN 24 is able to determine the endpoint of this initial burst period as occurring when UE 14 begins to request data at a certain steady-state delivery rate R. As discussed above and shown in FIG. 4, UE 14 will begin to request video chunks at a “throttled-back” delivery rate R at the end of the initial burst used to fill UE buffer 14.1. With respect to HAS video streaming, this rate R defines the number of bytes D delivered in a chunk period T. Referring to step 120, it is presumed that RAN 24 is initially able to utilize a transmission rate that matches the requested delivery rate. RAN 24 uses this initial delivery rate R to determine the number of bytes D to be delivered during the specified time interval. All things being equal, UE 14 will play out the oldest D bytes from buffer 14.1 as the newest D bytes are delivered, maintaining a constant “fill” level in buffer 14.1. Therefore, as long as UE 14 continues to request the same delivery rate R, the network will continue to deliver D bytes (as shown at step 140) and the estimate of the buffer depth remains (essentially) constant at Bᵢₙₜ. It is thus presumed that the user's QoE at least meets his/her expectations in this case.

If RAN 24 receives an updated, new delivery rate R_{new} from UE 14 (as flagged by decision step 130), RAN 24 proceeds to calculate the number of bytes D_{new} it must now deliver to maintain the same chunk interval T (step 140). This change in transmission rate from RAN 24 impacts, in turn, the depth of buffer 14.1 at UE 14. As shown at step 150, the process continues by using this new value of delivered bytes (D_{new}) to update the estimate the buffer “fill” level: B_{new}=Bᵢₙₜ−(D−D_{new}). Thus, B_{new} will be somewhat reduced, and the buffer will deplete by some amount.

The amount of buffer depletion is monitored in accordance with the disclosed subject matter in order to prevent video screen freeze from occurring. In particular, a buffer re-fill process is initiated when B_{new} reaches a certain level, denoted Bₜₕ, that is defined as a threshold value below which the buffer is in danger of emptying and causing video screen freeze. In particular, as mentioned above and shown at step 160, the calculated value of B_{new} is compared against the threshold value Bₜₕ stored at RAN 24. If B_{new}>Bₜₕ, the network has assurance that the buffer is still sufficiently full and the process returns to step 120 and continues. However, if B_{new}<Bₜₕ, the disclosed technique provides an alert that the buffer is close to emptying (step 170), and initiates a buffer refill process to increase the buffer depth. By controlling the value of Bₜₕ, RAN 24 is able to monitor the state of the buffer at UE 14 and take proactive steps to prevent video screen freeze related to buffer underfill.

In accordance with this aspect of the disclosed subject matter, this reduction in possibility of video screen freeze (and, therefore, an improvement in the user's QoE) is accomplished without the need to access information directly from either the UE or content provider; it is measured, maintained, and implemented all within the network itself.

Techniques to “rapidly” re-fill the almost-empty buffer of a given UE include, for example, increasing the user scheduler priority level, allowing for more spectral resources to be allocated to the in-need UE for a period of time until the buffer is determined to have been re-filled above its threshold level. Reference is made to our co-pending application U.S. Ser. No. 15/292,486 filed Oct. 13, 2016 and entitled “Scheduling Transmissions of Adaptive Bitrate Streaming” for a discussion of various options useful for this purpose.

Another impairment associated with HAS video flow takes the form of abrupt changes in the video stream quality attributed to abrupt changes in quality levels being requested by the RDA at the UE client. This can happen when the network is deep in congestion, and as a result is unable to deliver a consistent, steady transmission rate to the client (as needed for a smooth video playout). When there is congestion along the network, the UE may abruptly jump between different quality levels, and thus request abrupt changes in the requested delivery rate from the network.

One disclosed technique for addressing this impairment in video streaming and improving the QoE is to configure the RAN to perform only small, incremental changes in transmission rate (instead of merely complying with the changing delivery requests provided by the RDA). The use of small, incremental changes gives a smoother playout of the video, a better experience for the viewer.

It is to be understood that there is a need to make a distinction between underdelivery from RAN 24 itself, and congestion at HAS server 12, both of which can result in the appearance of “network congestion” from the point of view of UE 14. Indeed, processor 14.2 (implementing the RDA) does not know if the reduction in delivery rate received over the air interface is due to congestion at server 12 or impediments in the air interface itself. For the purposes of the present disclosure, an initial presumption is made that server 12 is not the source of the congestion. Based on that presumption, the transmission rate is lowered and RAN 24 continues to evaluate the performance and see if the number of requests to change the delivery rate subside. If they do, then lowering the delivery rate at RAN 24 addressed the problem.

However, if RAN 24 stills receives numerous requests to change the delivery rate, then server congestion must be the problem, and a solution to that problem is beyond the scope of the present disclosure.

Another source of disruption in video quality, which leads to lower levels of QoE, is the somewhat lengthy delay between requesting a particular video stream and the beginning of its playout on the designed UE device. Accordingly, this concern is addressed by prioritizing that specific UE during the initialization process so that the fills up as quickly as possible.

Summarizing, the techniques as described within the present disclosure allow for at least three key video QoE impairments to be observed within the network (for example, at a radio access network point): detection of video play freeze, detection of abrupt changes in quality level, and detection of long start-up times. As discussed above, the inventive techniques provide actions, that when taken after the detection of one or more of these impairments, can improve the video user QoE.

Importantly, the proposed solutions can be applied to encrypted traffic, where there is no way to obtain information that is contained within the packet headers (either HTTP packets or any other suitable form). The ability for the network to discern the QoE level without obtaining direct feedback from either the UE or the server is critical in providing this QoE assessment for encrypted traffic. The techniques described herein are non-intrusive and are based only on observation of the flows between the server and the UE client. There is no impact on data or control paths, and no additional probes need to be inserted in the network to assist in developing these QoE metrics.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising
monitoring, at a network element, changes in delivery rate requests for an HTTP adaptive streaming (HAS) video flow from a client user equipment (UE); and
modifying, as needed, delivery rates of on-going video stream segments from the network element to the UE based on requested changes from the UE.

2. The method of claim 1, wherein the modifying step comprises
determining, at the network element, an initial buffer depth Bᵢₙₜ of the UE and monitoring changes in buffer depth (B_{new}) as delivery rate changes; and
initiating buffer re-fill when the monitored buffer depth B_{new} falls below a predetermined threshold value Bₜₕ.

3. The method of claim 2, wherein determining step comprises
calculating, at the network element, a number of bytes delivered during an initial burst transmission period of video frames; and
defining the calculated number of bytes as the initial buffer depth Bᵢₙₜ.

4. The method of claim 2, wherein the network element recognizes a termination of the initial burst transmission period upon reception of a delivery rate request from the UE.

5. The method of claim 2, wherein the step of initiating buffer re-fill comprises
increasing scheduler priority associated with the UE so as to allocate additional spectral resources to the UE until the buffer depth approaches Bᵢₙₜ.

6. The method of claim 1, wherein the modifying step comprises
recognizing, at the network element, multiple requests for changes in the delivery rate from the UE during a relatively short time interval;
initially reducing the delivery rate from the network element to the UE to a rate below all requested delivery rates; and
incrementally increasing the delivery rate to maintain smooth delivery of video frames until reaching a delivery rate associated with an acceptable QoE.

7. The method of claim 1, wherein the modifying step comprises
recognizing, at the network element, an initiation of a HAS video flow to the UE;
increasing a priority associated with the UE so as to minimize a time required to fill the UE buffer.

8. The method of claim 1 wherein the HAS video flow comprises an encrypted HAS video flow.

9. The method of claim 1 wherein the network element comprises a radio access network (RAN) element.

10. An apparatus comprising:
a network element including a processor configured to monitoring, at a network element, changes in delivery rate requests for an HTTP adaptive streaming (HAS) video flow from a client user equipment (UE), and modify, as needed, delivery rates of on-going video stream segments from the network element to the UE based on requested changes from the UE.

11. The apparatus of claim 10, wherein the network element processor is configured to determine an initial buffer depth Bᵢₙₜ of the UE, monitor changes in buffer depth (B_{new}) as delivery rate changes, and initiate buffer re-fill when the monitored buffer depth B_{new} falls below a predetermined threshold value Bₜₕ.

12. The apparatus of claim 11 wherein the network element process is configured to calculate a number of bytes delivered during an initial burst transmission period of video frames and define the calculated number of bytes as the initial buffer depth Bᵢₙₜ.

13. The apparatus of claim 10 wherein the network element processor is configured to recognize multiple requests for changes in the delivery rate from the UE during a relatively short time interval, initially reduce the delivery rate from the network element to the UE to a rate below all requested delivery rates, and incrementally increasing the delivery rate to maintain smooth delivery of video frames until reaching a delivery rate associated with an acceptable QoE.

14. The apparatus of claim 10 wherein the network element processor is configured to recognize an initiation of a HAS video flow to the UE and increase the priority associated with the UE so as to minimize a time required to fill the UE buffer.

15. The apparatus of claim 10 wherein the network element comprises a radio access network element.

16. A non-transitory computer-readable medium embodying a set of instructions which when executed by a processor configure the processor to perform a method, the method comprising:
monitoring, at a network element, changes in delivery rate requests for an HTTP adaptive streaming (HAS) video flow from a client user equipment (UE); and
modifying, as needed, delivery rates of on-going video stream segments from the network element to the UE based on requested changes from the UE.

17. The non-transitory computer-readable medium of claim 16, wherein the method comprises determining, at the network element, an initial buffer depth Bᵢₙₜ of the UE and monitoring changes in buffer depth (B_{new}) as delivery rate changes, and initiating buffer re-fill when the monitored buffer depth B_{new} falls below a predetermined threshold value Bₜₕ.

18. The non-transitory computer-readable medium of claim 17, wherein the method comprises calculating, at the network element, a number of bytes delivered during an initial burst transmission period of video frames and defining the calculated number of bytes as the initial buffer depth Bᵢₙₜ.

19. The non-transitory computer-readable medium of claim 16, wherein the method comprises recognizing, at the network element, multiple requests for changes in the delivery rate from the UE during a relatively short time interval ,initially reducing the delivery rate from the network element to the UE to a rate below all requested delivery rates, and incrementally increasing the delivery rate to maintain smooth delivery of video frames until reaching a delivery rate associated with an acceptable QoE.

20. The non-transitory computer-readable medium of claim 16, wherein the method comprises recognizing, at the network element, an initiation of a HAS video flow to the UE, and increasing a priority associated with the UE so as to minimize a time required to fill the UE buffer.
